(19) United States
(12) Patent Application Publication
(10) Pub. No.: US 2013/0231889 A1
(43) Pub. Date: Sep. 5, 2013

(54) METHOD AND APPARATUS FOR AN INERTIAL NAVIGATION SYSTEM

(71) Applicants: Alex HRYBYK, Linthicum, MD (US); Kenneth R. Good, Odenton, MD (US)

(72) Inventors: Alex HRYBYK, Linthicum, MD (US); Kenneth R. Good, Odenton, MD (US)

(73) Assignee: LOCKHEED MARTIN CORPORATION, Bethesda, MD (US)

(21) Appl. No.: 13/409,892

(22) Filed: Mar. 1, 2012

(51) Int. Cl. G01P 15/00

(52) U.S. Cl. 702/141

(57) ABSTRACT

An approach is provided for determining a position of a device and/or a travel path of the device. A position of a device is defined as a first position. Accelerometer data associated with the device during a movement of the device from the first position to a second position is determined. The accelerometer data is processed to determine a step rate of a user of the device during the movement of the device from the first position to the second position. A step length of the user is determined from a user profile. A direction of movement of the device from the first position to the second position is determined. The step rate, the step length, and the direction of movement of the device are processed to determine a location of the second position with respect to the first position.

### FIELD OF DISCLOSURE

The disclosure relates to an apparatus, method and system for determining the position and/or travel path of a device independent of, or in addition to, conventional GPS triangulation.

### BACKGROUND

Service providers and device manufacturers (e.g., wireless, cellular, etc.) are continually challenged to deliver value and convenience to consumers by, for example, providing compelling network services. One area of interest involves determining the position and/or travel path of a device independent of, or in addition to, conventional GPS triangulation. Many mobile devices are equipped with global positioning system (GPS) receivers that can triangulate with satellites to estimate a device's position in longitude and latitude coordinates. GPS signals, however, are often unavailable, or too weak, to infer useful information. In the absence of this information, an alternative method of inferring position, or distance traveled, is needed.

### SUMMARY

Therefore, there is a need for an approach for determining the position and/or travel path of a device independent of, or in addition to, conventional GPS triangulation.

According to one embodiment, a method comprises causing, at least in part, a position of a device to be defined as a first position. The method also comprises determining accelerometer data associated with the device during a movement of the device from the first position to a second position. The method further comprises processing the accelerometer data to determine a step rate of a user of the device during the movement of the device from the first position to the second position. The method additionally comprises determining a step length of the user based, at least in part, on a user profile associated with the user. The method also comprises determining a direction of movement of the device during the movement from the first position to the second position. The method further comprises processing the step rate, the step length, and the direction of movement of the device to determine a location of the second position with respect to the first position.

According to another embodiment, an apparatus comprises at least one processor, and at least one memory including computer program code for one or more computer programs, the at least one memory and the computer program code configured to, with the at least one processor, cause, at least in part, the apparatus to cause, at least in part, a position of a device to be defined as a first position. The apparatus is also caused to determine accelerometer data associated with the device during a movement of the device from the first position to a second position. The apparatus is further caused to process the accelerometer data to determine a step rate of a user of the device during the movement of the device from the first position to the second position. The apparatus is additionally caused to determine a step length of the user based, at least in part, on a user profile associated with the user. The apparatus is also caused to determine a direction of movement of the device during the movement from the first position to the second position. The apparatus is further caused to process the step rate, the step length, and the direction of movement of the device to determine a location of the second position with respect to the first position.

According to another embodiment, a computer-readable storage medium carries one or more sequences of one or more instructions which, when executed by one or more processors, cause, at least in part, an apparatus to cause, at least in part, a position of a device to be defined as a first position. The apparatus is also caused to determine accelerometer data associated with the device during a movement of the device from the first position to a second position. The apparatus is further caused to process the accelerometer data to determine a step rate of a user of the device during the movement of the device from the first position to the second position. The apparatus is additionally caused to determine a step length of the user based, at least in part, on a user profile associated with the user. The apparatus is also caused to determine a direction of movement of the device during the movement from the first position to the second position. The apparatus is further caused to process the step rate, the step length, and the direction of movement of the device to determine a location of the second position with respect to the first position.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining the position and/or travel path of a device independent of, or in addition to, conventional GPS triangulation, according to one embodiment;

FIG. 2 is a diagram of the components of a navigation management platform, according to one embodiment;

FIG. 3 is a flowchart of a process for determining the position and/or travel path of a device independent of, or in addition to, conventional GPS triangulation, according to one embodiment;

FIG. 4 is a diagram of a user interface associated with determining the position and/or travel path of a device independent of, or in addition to, conventional GPS triangulation, according to one embodiment;

FIG. 5 is a diagram illustrating the collection and processing of sensor data, according to one embodiment;

FIG. 6 is a diagram an illustration that infers a direction of movement according to one embodiment;

FIG. 7 is a diagram of hardware that can be used to implement an embodiment of the invention;

FIG. 8 is a diagram of a chip set that can be used to implement an embodiment of the invention; and

FIG. 9 is a diagram of a mobile terminal (e.g., handset) that can be used to implement an embodiment of the invention.

### DESCRIPTION OF SOME EMBODIMENTS

Examples of a method, apparatus, and computer program for determining the position and/or travel path of a device independent of, or in addition to, conventional GPS triangulation are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

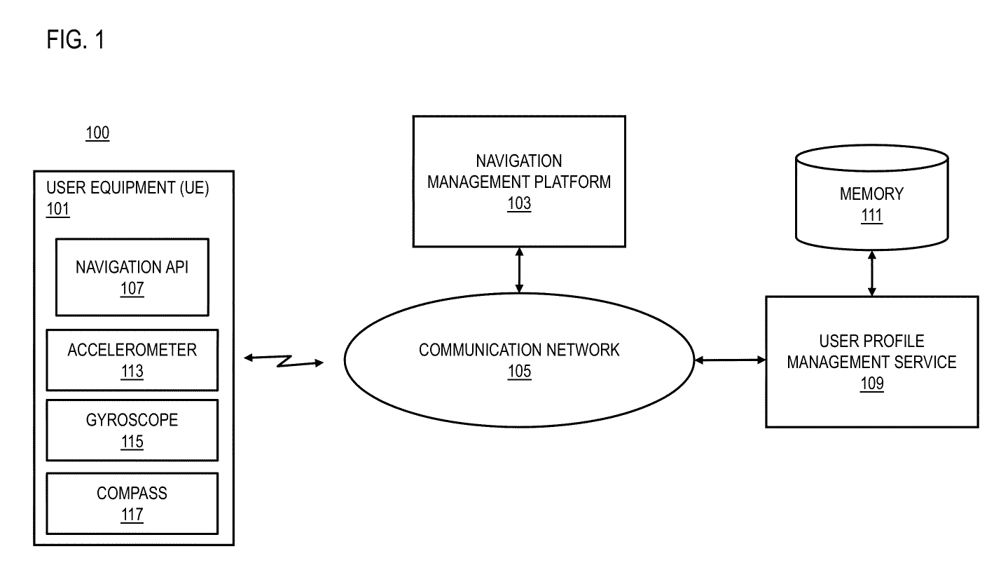

FIG. 1 is a diagram of a system capable of determining the position and/or travel path of a device independent of, or in addition to, conventional GPS triangulation, according to one embodiment.

Conventional smartphones (e.g., iPhone, Android, Nokia, Blackberry, etc.) are equipped with global positioning system (GPS) receivers that can triangulate with satellites to estimate one's position based on estimated longitude and latitude coordinates of the smartphone or other device. Knowing one's absolute position is extremely valuable in many situations, from navigation and path planning to situational awareness of both manned and unmanned agents, for example. In many cases, however, GPS signals are unavailable or too weak to infer useful information. For example, if the device is in a location such as a room with metallic (shielded) walls, a city with tall buildings that scatter and/or fade signals, or dense underground areas (e.g., caves, underwater, etc.), GPS signals may be unavailable or weak. In the absence of available GPS information, an alternative method of inferring position, or distance traveled, is needed.

Conventional methods to determine the position and/or travel path of a device independent of GPS triangulation, for example, are very prone to error. For example, personal dead reckoning is a method of inferring an object's location using sensors mounted on its body. Many methods use an accelerometer device that is part of the device or object to calculate location, but also use a GPS signal to determine accurate positioning and/or to correct any measurements. The most common method for estimating how far a person has travelled (without a GPS) is first counting the steps a user associated with a device takes during a movement by counting zero-crossings in an accelerometer signal generated by the accelerometer associated with the device. For example, such a method may use a pedometer associated with the device. In addition to counting steps, the user's stride length must also be determined. For determining a user's stride length, empirical formulas have been developed to show the relationship between statistics of the acceleration signal and the determined stride length. In conventional systems, the determined stride length is usually proportional to some unknown constant which must be calibrated for each user every time the conventional system is used. Problems arise in conventional systems if the number of steps or step length is miscalculated. That error can accumulate throughout the use of the conventional system, which can result in a large resultant location error.

To address this problem, a system 100 of FIG. 1 introduces the capability to determine the position and/or travel path of a device independent of, or in addition to, GPS triangulation. The system 100 may be applicable for any number of uses such as, but not limited to, military applications for tracking a user's position during a mission, for example, in locations where conventional GPS systems may be limited, as discussed above, for recreational uses such as spelunking, hunting, etc., as well as any number of other personal uses such as determining a pedestrian's position in a big city so that he does not get lost, etc. Additionally, the system 100 may be configured to present the user's location by way of the UE 101 or to share the user's location to others having access to the system 100, for example.

Mobile devices such as smartphones, tablets, laptops, etc. often have various sensors such as an accelerometers, gyroscopes and/or compasses incorporated into the device, or associated with the device. In one or more embodiments, a position of a device and/or a travel path or distance travelled by the device may be determined using data collected by these sensors, and processing this data using a unique algorithm. Accordingly, a user's position may be inferred based on his association with the device.

As shown in FIG. 1, the system 100 comprises a user equipment (UE) 101 having connectivity to a navigation management platform 103, user profile management service 109, and a memory 111 via a communication network 105. Alternatively, in one or more embodiments, the navigation management platform 103 may be on board the UE 101. Additionally, the UE 101 may have accessibility to a navigation API 107 that may be affiliated with the navigation management platform 103 to determine a position and/or travel path of the UE 101, and for displaying such information by way of the UE 101, for example.

In one or more embodiments, the UE 101 may have various sensors such as, but not limited to, an accelerometer 113, a gyroscope 115, and/or a compass 117 built-into the UE 101, or associated with the UE 101. As discussed above, a position of a device, such as UE 101, relative to a starting location (x0,y0), for example, and/or a travel path or distance travelled by the UE 101 from the starting location (x0,y0) may be determined using data collected by these sensors, and processing this data using a unique algorithm A user's position relative to the starting location (x0,y0) may accordingly be inferred based on his association with the UE 101.

In one or more embodiments, the starting location (x0,y0) may be fixed or variable. For example, from the moment a user starts using the navigation API 107, the system 100 may fix the starting position and continually determine the user's position based on continual collection of data from the sensors 113, 115, and 117, for example. In other words, the position of the UE 101 may always be known. Alternatively, the starting location (x0,y0) may change, for instance if its location services are deactivated and reactivated at a later time, or if the navigation API 107 is caused to start tracking a position of the of the UE 101 from a particular moment or location. The starting position may also be considered to change and caused to reset each time a direction of movement changes, for example.

According to various embodiments, the navigation management platform 103 may use data collected by the accelerometer 113 and apply a unique algorithm to determine a position and/or a distance travelled by a user carrying the UE 101. By placing the UE 101 in a user's pocket, bag, backpack, hand, satchel, belt clip, etc., for example, while the user walks or runs, the navigation management platform 103 may determine the natural rhythm with which the UE 101 accelerates as the user moves based on the data provided by the accelerometer 113. The navigation management platform 103 may analyze the accelerometer data using a frequency-domain based estimation technique to determine the user's current speed, or frequency of steps. In one or more embodiments, the navigation management platform 103 may perform a Fast Fourier Transform of the accelerometer data to determine the instantaneous speed (or frequency of steps) of the UE 101. The system 100 provides a more robust approach to inferring a person's location by determining a position of the UE 101 compared to conventional methods. Rather than counting steps directly such as that done by conventional systems, the navigation management platform 103's performance of the Fast Fourier Transform of the accelerometer data provides the instantaneous speed of the UE 101 during a movement rather than a conventional estimated value. The Fast Fourier Transform indicates dominant frequencies of user steps to appropriately infer an accurate estimation of a user's step rate compared to conventional methods. Experimental data indicates that the accuracy may be within a tolerance of plus or minus two steps for every 500 steps.

In one or more embodiments, to determine a distance travelled, a user's step length may also be part of a calculation performed by the navigation management platform 103. For example, the user's step length may be determined during a training session in which data provided by the accelerometer 113 and/or gyroscope 115 is processed to determine the user's step length. The determined user step length may be personal to a particular user, and a personal model that indicates a particular user's walking style may be generated. In one or more embodiments, the personal model that indicates a user's step length and/or walking style may be stored as part of a user profile for later recall and use, or stored in a memory associated with the UE 101, for example. The user profile that associates a determined step length with a particular user may be managed by the user profile management service 109 and stored in the memory 111 for later recollection by the UE 101 when the navigation management platform 103 needs the user's step length to calculate a distance travelled by the UE 101. The training session that is used to determine a user's specific step length, because it is stored by the user profile management service 109, or stored on the UE 101, may be performed by the user only once (rather than every time a distance travelled is determined like conventional systems).

In one or more embodiments, the user profile management service 109 may store additional user information in the user profile such as multiple step lengths that are based on a user's determined speed. For example, a user may have different step lengths when walking, long distance running, sprinting etc. Accordingly, the navigation API 107 may have an option for indicating what the user of the UE 101 is doing before embarking on a journey such as a walk or run, or the navigation management platform 103 may infer what the user is doing based on data collected from the accelerometer 113. For example, if the data collected from the accelerometer, when processed, indicates that the user is running, the navigation management platform 103 may apply the user's step length that is associated with running. However, should the accelerometer data indicate that the user has slowed down to a walk, or sped up to a sprint, the navigation management platform 103 may accordingly apply the appropriate step length associated with that action as it is available in the user profile.

In one or more embodiments, the user of the UE 101 may train the step length to be a particular length in the training session and have that step length stored in the user profile for later recollection. If only one step length is available the navigation management platform 103 may apply that step length regardless of an inferred activity. Or, if multiple step lengths are available, the navigation management platform 103 may apply an optimal step length that makes sense for that particular determined action. For example, if step lengths are available for a walk and for a run, but the user is determined to be running faster than the training session's determined step length for a run, the navigation management platform 103 will apply the step length that is appropriately applicable (i.e. a step length that is for the determined speed or greater, for example). Optionally, the navigation management platform 103 may be preconfigured to adjust a determined step length a predefined amount based on the determined speed, as well as other parameters that may be included in the user profile such as user age, height, weight, etc. if varying step lengths are limited or unavailable.

In one or more embodiments, the navigation management platform 103 may be caused to determine a direction of travel of the UE 101 during a movement. The direction of travel, combined with the determined speed and step length recalled from the user profile, may be used to determine a position of the UE 101 relative to a starting position, for example. Additionally, a travel path may be determined based on any determined change in direction and distance travelled by the UE 101 during a movement of the UE 101 from the starting position to any final position.

The direction of movement may be determined any number of ways. According to various embodiments, as discussed above, the UE 101 may include or be affiliated with a compass 117. The direction of movement may be indicated by the compass 117 and communicated to the navigation management platform 103.

Alternatively, or in addition to the indicated direction of movement provided by the compass 117, the navigation management platform 103 may receive data from the gyroscope 115, or any other sensor that may be used to indicate an angular velocity of the UE 101 during a movement from a starting position to another position. In one or more embodiments, the navigation management platform 103 may process the angular velocity data and integrate this data with respect to time. Such a processing of integrating the angular velocity signal from the gyroscope 115, for example, infers direction of movement.

According to various embodiments, the navigation management platform 103 processes the determined speed or frequency of steps, the recalled user step length and the determined direction of movement to calculated a location of, and a path taken to, another position. In one or more embodiments, the another position may be determined relative to the starting position. According to various embodiments, the another position, any final position, and/or the travel path may be presented to the user by way of the UE 101, stored in the user profile by way of the user profile management service 109, or presented to, or shared with, others that may use or have access to the system 100 by way of another UE 101, or by way of the user profile management service 109, which may be a social networking or system oversight service, for example.

By way of example, the communication network 105 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UE 101, the navigation management platform 103, and the user profile management service 109 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

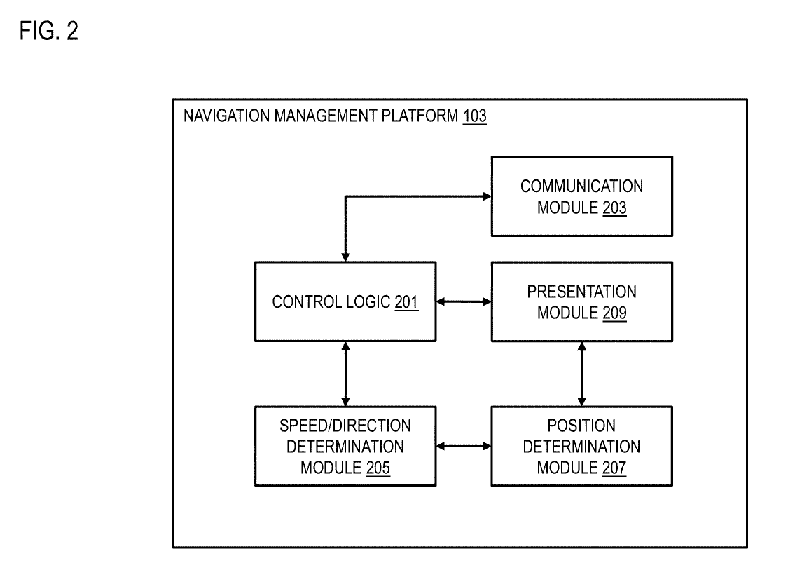

FIG. 2 is a diagram of the components of the navigation management platform 103, according to one embodiment. By way of example, the navigation management platform 103 includes one or more components for determining the position and/or travel path of a device independent of, or in addition to, conventional GPS triangulation. It is contemplated that the functions of these components may be combined in one or more components or performed by other components of equivalent functionality. In this embodiment, the navigation management platform 103 includes a control logic 201, a communication module 203, a speed/direction determination module 205, a position determination module 207, and a presentation module 209.

In one or more embodiments, the navigation management platform 103 receives an indication of a movement by the UE 101 from the navigation API 107 by way of the communication module 203. The indication of the movement may be based, for example, on data associated with the accelerometer 113, the gyroscope 115 and/or the compass 117. The navigation API 107, as discussed above, may continually be active, or may be activated on demand. As such, the indication of movement may be sent any time the UE 101 moves, or it may be sent only when the navigation API 107 is activated.

According to various embodiments, the indication of movement may simply be a message that asks for permission from the navigation management platform 103 to allow transmission of data associated with the movement, or it may itself be a packet that includes data associated with the movement. For example, the data associated with the movement may include, but not be limited to, accelerometer data provided by the accelerometer 113, gyroscope data provided by the gyroscope 115, compass data provided by the compass 117, or data associated with any other sensor.

In one or more embodiments, the control logic 201, causes the speed/direction determination module 205 to process the accelerometer data, the gyroscope data and/or the compass data to determine a speed or frequency of steps and a direction of movement of the UE 101. As discussed above, the accelerometer data may be processed using a Fast Fourier Transform to determine the instantaneous speed of the UE 101 during the movement. Additionally, the direction, if determined based on the gyroscope data, may be determined by integrating the gyroscope data (or other data) that indicates the angular velocity of the UE 101 with respect to time to infer the direction of movement of the UE 101.

In one embodiment, the navigation API 107 may be in a training mode. In the training mode, the control logic 201 causes the speed/direction determination module 205 to determine a user's step length. As discussed above, the user's step length may be unique to a particular user and stored in a user profile by way of the user profile management service 109 or on the UE 101.

According to various embodiments, the control logic 201 causes the position determination module 207 to recall the user profile information having the user's determined step length, and combine this data with the determined speed (or frequency of steps) of the UE 101 and the determined direction of movement of the UE 101 to determine a position of the UE 101 relative to a starting position by calculating the distance travelled by the UE 101 based on the number of steps and length of user step in the determined direction.

In one or more embodiments, the navigation management platform 103 may be configured, for example, to set a starting position as (x0, y0), for example. The UE 101 may move in a first direction, 30 degrees from a normal position associated with the starting position, for example, from the starting position to a second position. The navigation management platform 103 may determine the distance travelled from the starting position to the second position and determine the location of the second position. Then, if the user changes directions, for example to 45 degrees from the normal position associated with the starting position, the navigation management platform 103 may cause, for distance and angular calculation purposes, the starting position to be reassigned to the location of the second position so that it can determine a distance of movement from the second position to a third position, for example at the end of the movement 45 degrees from the normal position associated with the starting position. The navigation management platform 103 may accordingly determine the location of the third position relative to the second position, which is relative to the starting position and the path travelled therebetween.

In one or more embodiments, the series of movements may be linked together so that they may be caused to be illustrated as a travel path on a display by the presentation module 209, for example. Additionally, any of the starting position, second position, third position, or any number of determined positions therefrom may be caused to be illustrated, and/or linked to display where the UE 101 is, or has been, and how it got to any determined position, by the presentation module 209. The control logic 201 may then cause the presentation module 209 to communicate the illustrated location of the determined position and/or the determined travel path to the navigation API 107, other UE 101, and/or the user profile management service 109 by way of the communication module 203.

It should be noted, that while the above example discusses movement from a first position, to a second position and ultimately to a third position, any number of positions and directional changes may be determined by the navigation management platform 103 to infer a position of the UE 101 and/or plot a travel path of the UE 101 from the assigned starting position to any determined position.

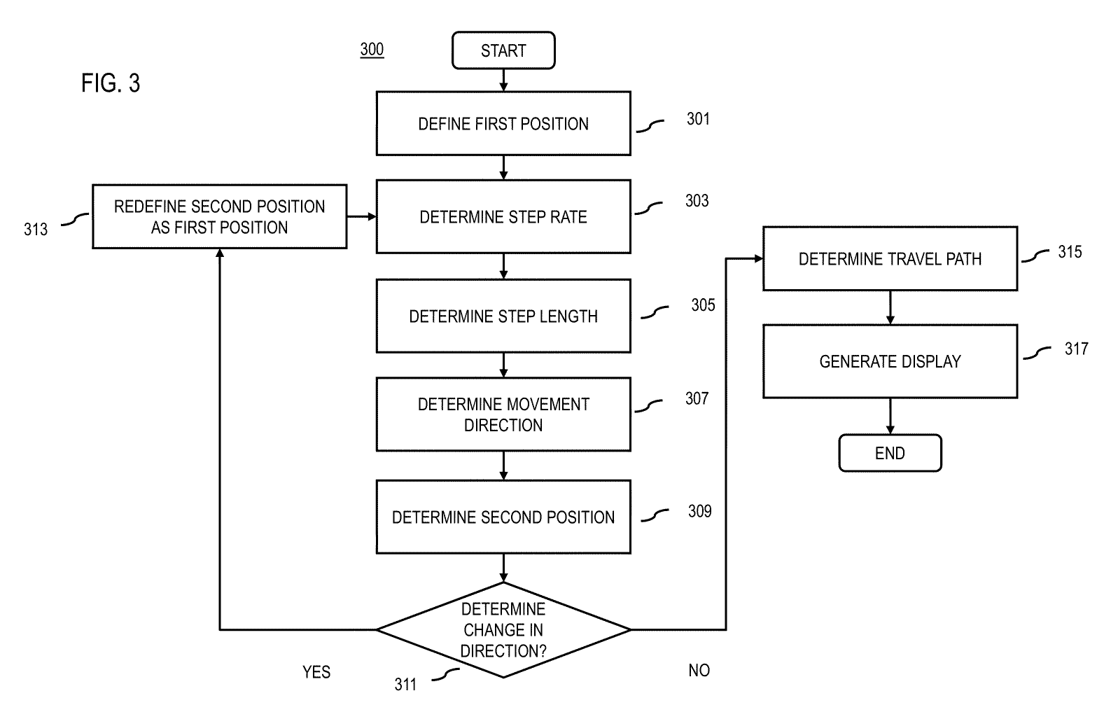

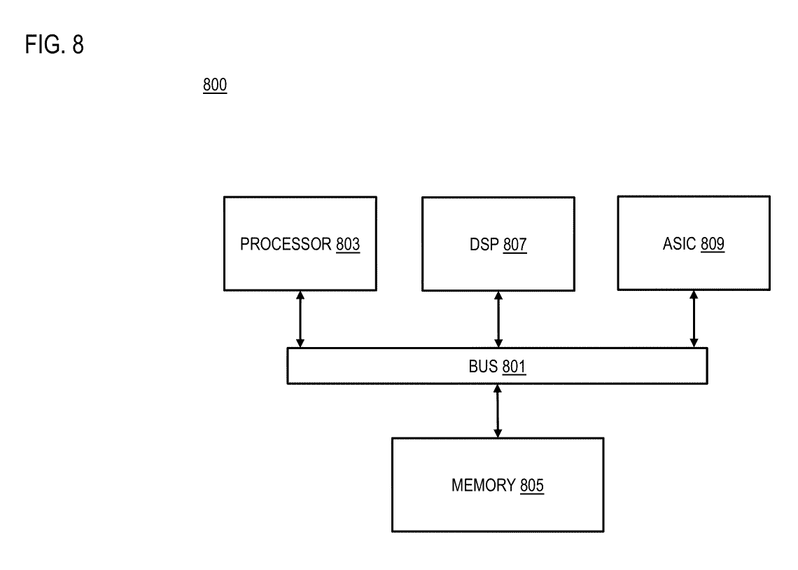

FIG. 3 is a flowchart of a process for determining the position and/or travel path of a device independent of, or in addition to, conventional GPS triangulation, according to one embodiment. In one embodiment, the navigation management platform 103 performs the process 300 and is implemented in, for instance, a chip set including a processor and a memory as shown in FIG. 8. In step 301, navigation management platform 103 causes, at least in part, a position of a device such as the UE 101 to be defined as a first position. The first position, at discussed above, may be set at a position (x0, y0), or (x0, y0, z0), for example. The first position may also be determined as any set of coordinates available to the UE 101 for associating that determined position or a particular coordinate set such as latitude and longitude, for example, if available to the UE 101. The process continues to step 303 in which the navigation management platform 103 determines accelerometer data provided by way of an accelerometer associated with the UE 101 during a movement of the UE 101 from the first position to a second position. The second position is undefined until the movement is determined to stop (at which point its location is determined by the process 300), for example, or it may be determined based on a particular moment in time, for example. In one or more embodiments, for example, the moment in time may be 30 seconds (although any moment in time may be applicable) after the movement from the first position begins. As such, while the UE 101 is still in motion, a snapshot may be taken of the information available to the navigation management platform 103 so that the location of the UE 101 may be determined at any moment. Such a determination may be useful if the movement of the UE 101 is being tracked, for instance, if a user's whereabouts are wanted to be known without stopping, and/or so that the movement of the UE 101 may be animated as the UE 101 moves from the first position to any subsequent position, for example.

In step 303, the navigation management platform 103 processes the accelerometer data using a Fast Fourier Transform to determine a step rate of a user of the UE 101 during the movement of the UE 101 from the first position to the second position. In one or more embodiments, the accelerometer data indicates a rhythm with which the device accelerates during the movement of the UE 101 from the first position to the second position.

Then, in step 305, the navigation management platform 103 determines a step length of the user based, at least in part, on a user profile associated with the user. The user profile, as discussed above, may be established by way of a training session so that the user profile management service 109 may store information related to any particular user associated with the device. The training session may be caused by the navigation management platform 103 to occur so that the user profile is generated for later use in determining the position and/or travel path of the UE 101. Accordingly, once generated, any user may use any number of UE 101's, whether the UE 101 is his own or that of another user, and once logged-in to the UE 101, or appropriately associated with the UE 101, and have his user profile applied to provide accurate step length information for position and/or travel path determination.

The process continues to step 307 in which the navigation management platform 103 determines a direction of movement of the UE 101 during the movement from the first position to the second position. The direction of movement may be determined by way of any sensor such as a compass 117 associated with the UE 101 or a gyroscope 115, for example. If the gyroscope 115 is used, the navigation management platform 103 processes the gyroscope data, which may provide an angular velocity of the UE 101 during the movement of the UE 101 from the first position to the second position, by integrating the angular velocity with respect to time to infer the direction of movement of the UE 101 from the first position to the second position.

Then, in step 309, the navigation management platform 103 processes the step rate, the step length, and the direction of movement (regardless of how it is determined) of the UE 101 to determine a location of the second position with respect to the first position. The location of the second position may be provided as (x, y) coordinates, latitude/longitude coordinates, (x, y, z) coordinates, etc.

Next, in step 311, the navigation management platform 103 determines whether the UE 101 changes direction at any moment during a movement. If the navigation management platform 103 determines a change in the direction of movement of the UE 101 from the initial direction of movement of the UE 101 from the first position to the second position to another direction of movement of the UE 101, the process continues to step 313 in which the navigation management platform 103 causes, at least in part, the second position to be defined as another first position. In other words, for distance and direction calculation purposes, the first position is reset so that a new second position can be determined relative to the initial second position which has been redefined as the new first position. Then, the process accordingly repeats so that the navigation management platform determines additional accelerometer data associated with the UE 101 during a movement of the UE 101 from the another first position to another second position.

The navigation management platform also processes the additional accelerometer data to determine another step rate of the user of the UE 101 during the movement of the UE 101 from the another first position to the another second position. For instance, once the user changes directions, the user may pick up pace or slow down. Then, the navigation management platform 103, after it determines the change in direction to the another direction, determines the another direction of movement of the UE 101 during the movement of the UE 101 from the another first position to the another second position. Next, the navigation management platform 103 processes the another step rate, the step length, and the another direction of movement of the device from the another first position to the another second position to determine a location of the another second position with respect to the another first position.

The process returns to step 311 and if the navigation management platform 103 determines another change in direction, the process accordingly repeats, but if the navigation management platform determines that no change in direction has occurred since the movement began, or since the last determined change in direction, the navigation management platform may, in step 315, determine an overall travel path based, at least in part, on a compilation of one or more individual travel paths generated based on the movement from the first position to the second position, the movement from the another first position to the another second position, one or more other movements from one or more other first positions to one or more respective other second positions, or any combination thereof. For example, the navigation management platform 103 may link all of the determined movements of the UE 101 together to compile an overall travel path from the first position to a final position which may be the second position, or any number of second positions that later result from continual changes in direction until the UE 101 stops, or a time sampling is taken.

The process continues to step 317 in which the navigation management platform 103 causes, at least in part, one or more of the first position, the second position, the another first position, the another second position, the one or more other first positions, the one or more respective other second positions, individual travel paths, the overall travel path, or any combination thereof to be displayed. The displaying may be by way of the UE 101, another UE 101, the user profile management service 109, or any other device affiliated with the system 100 to the user and/or other users.

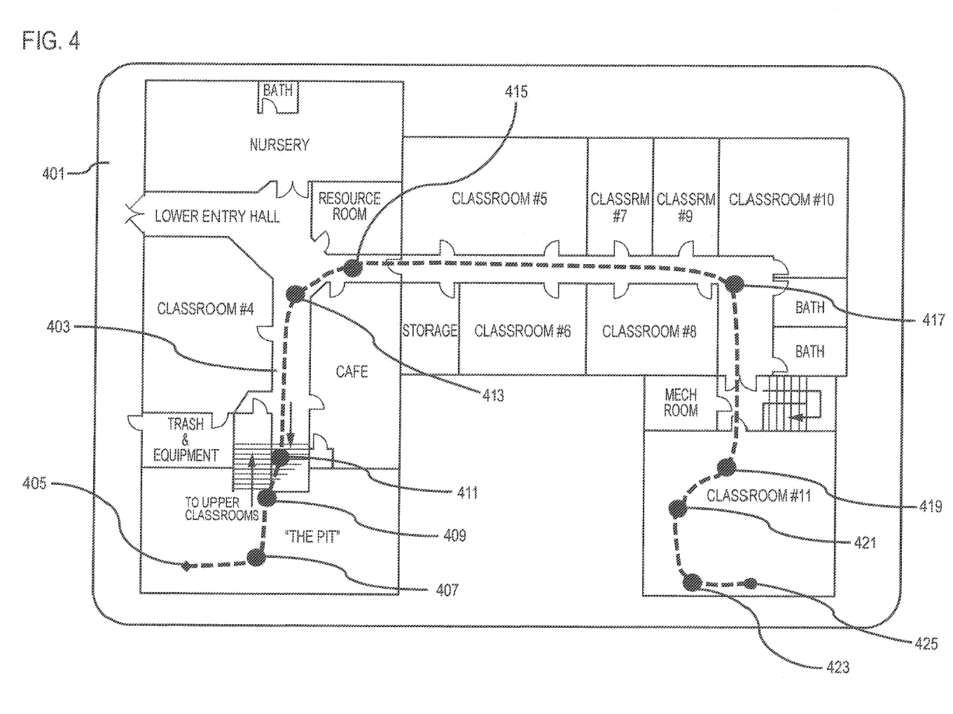

FIG. 4 is a diagram of a user interface 401 associated with the navigation API 107, or other means for viewing a compiled travel path 403.

In this example, a user of a UE 101 moves from a first position 405 to a second position 407. The travel path 403 may be plotted based on the determination of respective locations of multiple positions 407, 409, 411, 413, 415, 417, 419, 421, 423 and 425, for example. The position 407 may be determined, for example, based on accelerometer data, step length (which may be based on accelerometer data and/or user profile data) and directional data processed by the navigation management platform 103. If the navigation management platform 103 determines a change in direction, the first position 405 is accordingly plotted, the position 407 is accordingly plotted, and the movement progresses from the position 407 to the position 409, at which point the navigation management platform 103, in this example, determines another change in direction, and causes the position 409 to be plotted. The determination of movement distance, movement direction, and direction changes continues until position 411, etc. all the way to position 425 until movement of the UE 101 is ceased, or a movement snapshot in time is taken, for example.

In one or more embodiments, the travel path 403 may be compiled and plotted, or any of the first, second or any other position may be plotted individually. For example, what is illustrated may only show the first position 405 and the end position 425 and no connection between them, it may show the travel path 403 taken to get to the position 425 from the first position 405, or it may show each of the start and stop positions 405 and 425, and/or each of the positions associated with each change in direction (positions 407-423) with or without the travel path 403 being illustrated.

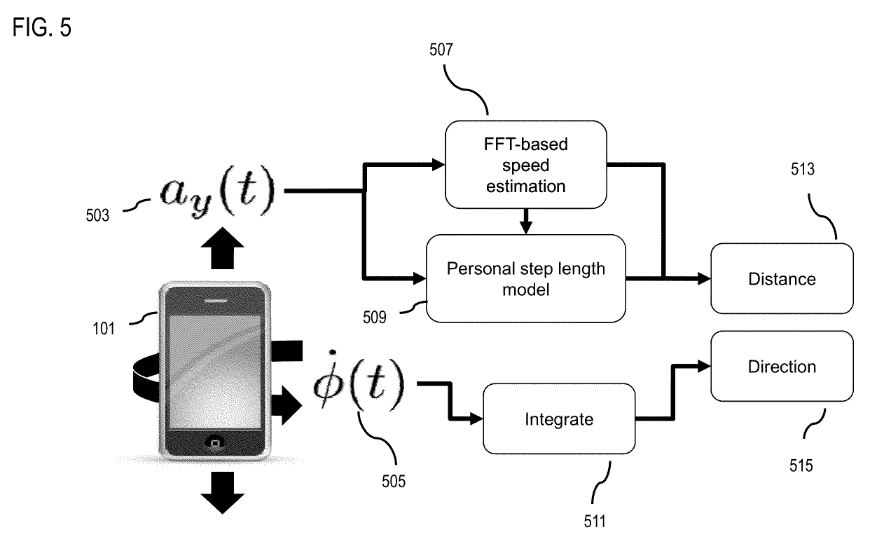

FIG. 5 illustrates the collection of accelerometer and gyroscope data associated with the UE 101 to approximate step-rate and step-length for forming a joint estimation of distance travelled and direction of movement of a device to determine the device's location relative to a starting position.

According to various embodiments, the UE 101 has various sensors as discussed above. The sensors may include an accelerometer 113 that provides accelerometer data 503 to the navigation management platform 103. The UE 101 may also comprise a gyroscope 115 that provides gyroscope data 505 to the navigation management platform 103.

The accelerometer data 503, for example, is illustrated as being an up/down motion that may be used to by the navigation management platform 103 to determine a frequency and step length of a user as the UE 101 moves from a first position to a second position. While the accelerometer data 503 is illustrated as being up and down, the accelerometer data 503 may be in any direction that may cause a rhythm of movement to be inferred. The navigation management platform 103, as discussed above, processes the accelerometer data 503 by performing a Fast Fourier Transform at step 507 to estimate the speed at which the user is moving or taking his steps. The navigation management platform 103 may also determine a step length from the accelerometer data 503 during a training session so that it may be combined with the processed accelerometer data to determine a distance travelled by the UE 101 during a movement from the first position to the second position.

The gyroscope 115, as discussed above, provides gyroscope data 505 to the navigation management platform 103. This gyroscope data indicates an angular velocity of the UE 101 and is integrated with respect to time to infer a direction of movement at step 511. The direction of movement of the UE 101 is determined at step 513. Both the determined direction of movement and the distance travelled, as discussed above, may be used by the navigation management platform 103 to determine a position of the UE 101 relative to a starting position.

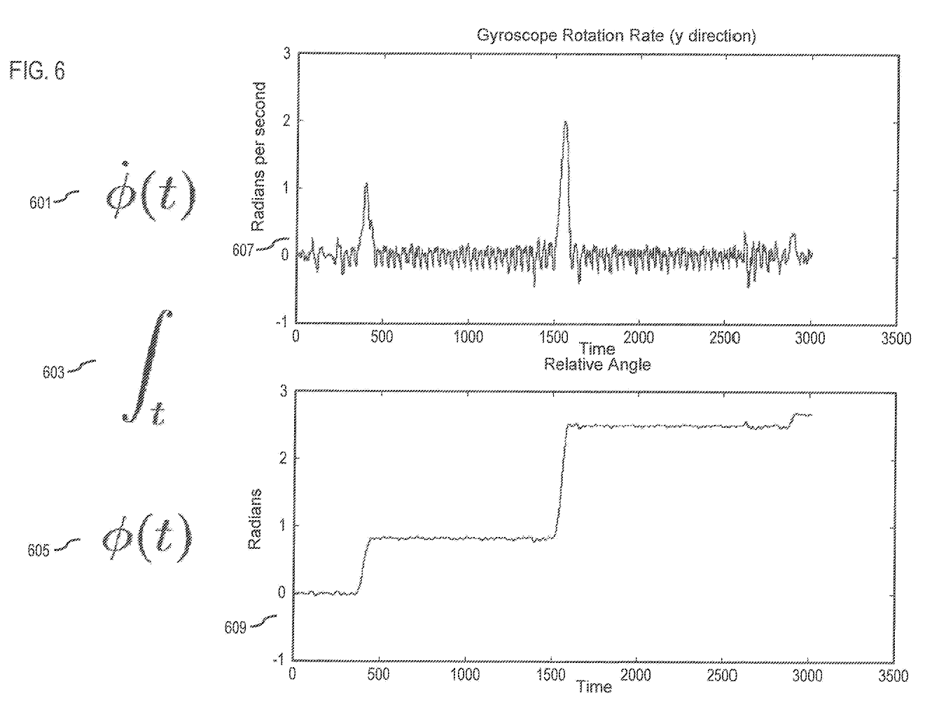

FIG. 6 illustrates a process of filtering and integrating of the angular velocity data of the UE 101 provided by the gyroscope 115, for example. The gyroscope data 505 discussed above provides angular velocity 601 as a rotation-signal. The angular velocity 601 is integrated at 603 by the navigation management platform 103 with respect to time to produce radians 605 which may be used to infer a direction of travel. For example, when the angular velocity 601 is measured in radians/second and plotted versus time, the graph 607 is generated and looks like a variable signal. Then, when the angular velocity 601 is integrated at 603 and radians 605 are produced, the radians 605 when plotted versus time generates a graph 609. Graph 609 infers a direction of travel for a particular period of time, and any directional change that may occur during movement of the UE 101. For example, each time the graph jumps to a different radian value, this change indicates a change of direction of movement of the UE 101. In one or more embodiments, the navigation management platform 103 may be configured filter out slight changes in direction that may not be considered to greatly affect the overall direction of movement of the UE 101. For example, in the graph 609, between major radian lines that are generally horizontal on the graph may be used to calculate the direction of movement, while the portions of the graph that are not dominant directions (i.e. those that are slanted or curved) may be filtered out of any direction/location determination calculation.

The processes described herein for determining the position and/or travel path of a device independent of, or in addition to, conventional GPS triangulation may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

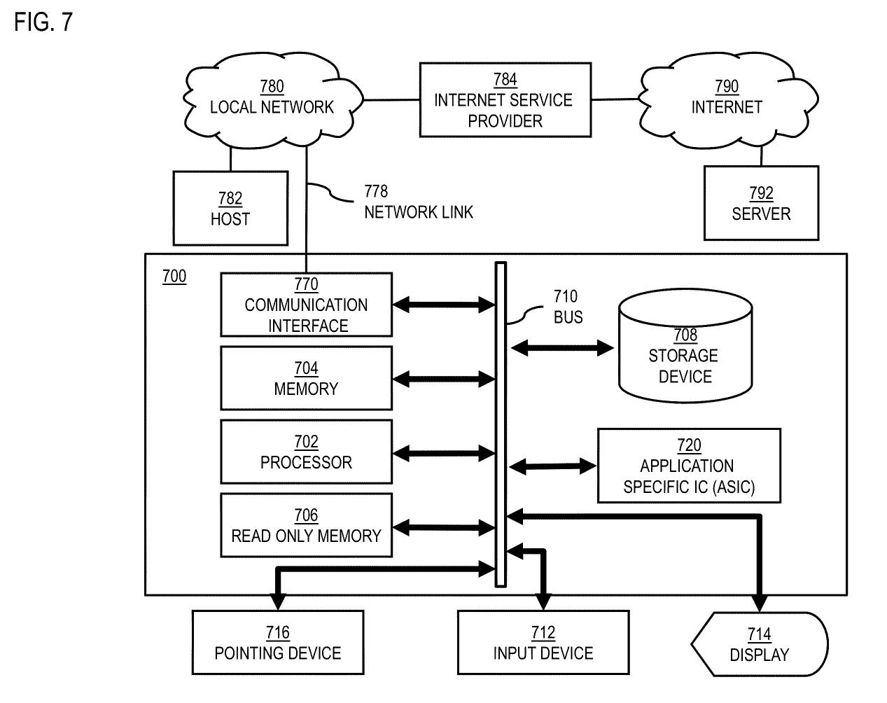

FIG. 7 illustrates a computer system 700 upon which an embodiment of the invention may be implemented. Although computer system 700 is depicted with respect to a particular device or equipment, it is contemplated that other devices or equipment (e.g., network elements, servers, etc.) within FIG. 7 can deploy the illustrated hardware and components of system 700. Computer system 700 is programmed (e.g., via computer program code or instructions) to for determining the position and/or travel path of a device independent of, or in addition to, conventional GPS triangulation as described herein and includes a communication mechanism such as a bus 710 for passing information between other internal and external components of the computer system 700. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 700, or a portion thereof, constitutes a means for performing one or more steps of determining the position and/or travel path of a device independent of, or in addition to, conventional GPS triangulation.

A bus 710 includes one or more parallel conductors of information so that information is transferred quickly among devices coupled to the bus 710. One or more processors 702 for processing information are coupled with the bus 710.

A processor (or multiple processors) 702 performs a set of operations on information as specified by computer program code related to determining the position and/or travel path of a device independent of, or in addition to, conventional GPS triangulation. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 710 and placing information on the bus 710. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 702, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 700 also includes a memory 704 coupled to bus 710. The memory 704, such as a random access memory (RAM) or any other dynamic storage device, stores information including processor instructions for determining the position and/or travel path of a device independent of, or in addition to, conventional GPS triangulation. Dynamic memory allows information stored therein to be changed by the computer system 700. RAM allows a unit of information stored at a location called a memory address to be stored and retrieved independently of information at neighboring addresses. The memory 704 is also used by the processor 702 to store temporary values during execution of processor instructions. The computer system 700 also includes a read only memory (ROM) 706 or any other static storage device coupled to the bus 710 for storing static information, including instructions, that is not changed by the computer system 700. Some memory is composed of volatile storage that loses the information stored thereon when power is lost. Also coupled to bus 710 is a non-volatile (persistent) storage device 708, such as a magnetic disk, optical disk or flash card, for storing information, including instructions, that persists even when the computer system 700 is turned off or otherwise loses power.

Information, including instructions for determining the position and/or travel path of a device independent of, or in addition to, conventional GPS triangulation, is provided to the bus 710 for use by the processor from an external input device 712, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 700. Other external devices coupled to bus 710, used primarily for interacting with humans, include a display device 714, such as a cathode ray tube (CRT), a liquid crystal display (LCD), a light emitting diode (LED) display, an organic LED (OLED) display, a plasma screen, or a printer for presenting text or images, and a pointing device 716, such as a mouse, a trackball, cursor direction keys, or a motion sensor, for controlling a position of a small cursor image presented on the display 714 and issuing commands associated with graphical elements presented on the display 714. In some embodiments, for example, in embodiments in which the computer system 700 performs all functions automatically without human input, one or more of external input device 712, display device 714 and pointing device 716 is omitted.

In the illustrated embodiment, special purpose hardware, such as an application specific integrated circuit (ASIC) 720, is coupled to bus 710. The special purpose hardware is configured to perform operations not performed by processor 702 quickly enough for special purposes. Examples of ASICs include graphics accelerator cards for generating images for display 714, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 700 also includes one or more instances of a communications interface 770 coupled to bus 710. Communication interface 770 provides a one-way or two-way communication coupling to a variety of external devices that operate with their own processors, such as printers, scanners and external disks. In general the coupling is with a network link 778 that is connected to a local network 780 to which a variety of external devices with their own processors are connected. For example, communication interface 770 may be a parallel port or a serial port or a universal serial bus (USB) port on a personal computer. In some embodiments, communications interface 770 is an integrated services digital network (ISDN) card or a digital subscriber line (DSL) card or a telephone modem that provides an information communication connection to a corresponding type of telephone line. In some embodiments, a communication interface 770 is a cable modem that converts signals on bus 710 into signals for a communication connection over a coaxial cable or into optical signals for a communication connection over a fiber optic cable. As another example, communications interface 770 may be a local area network (LAN) card to provide a data communication connection to a compatible LAN, such as Ethernet. Wireless links may also be implemented. For wireless links, the communications interface 770 sends or receives or both sends and receives electrical, acoustic or electromagnetic signals, including infrared and optical signals, that carry information streams, such as digital data. For example, in wireless handheld devices, such as mobile telephones like cell phones, the communications interface 770 includes a radio band electromagnetic transmitter and receiver called a radio transceiver. In certain embodiments, the communications interface 770 enables connection to the communication network 105 for determining the position and/or travel path of a device independent of, or in addition to, conventional GPS triangulation to the UE 101.

The term “computer-readable medium” as used herein refers to any medium that participates in providing information to processor 702, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 708. Volatile media include, for example, dynamic memory 704. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 720.

Network link 778 typically provides information communication using transmission media through one or more networks to other devices that use or process the information. For example, network link 778 may provide a connection through local network 780 to a host computer 782 or to equipment 784 operated by an Internet Service Provider (ISP). ISP equipment 784 in turn provides data communication services through the public, world-wide packet-switching communication network of networks now commonly referred to as the Internet 790.

A computer called a server host 792 connected to the Internet hosts a process that provides a service in response to information received over the Internet. For example, server host 792 hosts a process that provides information representing video data for presentation at display 714. It is contemplated that the components of system 700 can be deployed in various configurations within other computer systems, e.g., host 782 and server 792.

At least some embodiments of the invention are related to the use of computer system 700 for implementing some or all of the techniques described herein. According to one embodiment of the invention, those techniques are performed by computer system 700 in response to processor 702 executing one or more sequences of one or more processor instructions contained in memory 704. Such instructions, also called computer instructions, software and program code, may be read into memory 704 from another computer-readable medium such as storage device 708 or network link 778. Execution of the sequences of instructions contained in memory 704 causes processor 702 to perform one or more of the method steps described herein. In alternative embodiments, hardware, such as ASIC 720, may be used in place of or in combination with software to implement the invention. Thus, embodiments of the invention are not limited to any specific combination of hardware and software, unless otherwise explicitly stated herein.

The signals transmitted over network link 778 and other networks through communications interface 770, carry information to and from computer system 700. Computer system 700 can send and receive information, including program code, through the networks 780, 790 among others, through network link 778 and communications interface 770. In an example using the Internet 790, a server host 792 transmits program code for a particular application, requested by a message sent from computer 700, through Internet 790, ISP equipment 784, local network 780 and communications interface 770. The received code may be executed by processor 702 as it is received, or may be stored in memory 704 or in storage device 708 or any other non-volatile storage for later execution, or both. In this manner, computer system 700 may obtain application program code in the form of signals on a carrier wave.

Various forms of computer readable media may be involved in carrying one or more sequence of instructions or data or both to processor 702 for execution. For example, instructions and data may initially be carried on a magnetic disk of a remote computer such as host 782. The remote computer loads the instructions and data into its dynamic memory and sends the instructions and data over a telephone line using a modem. A modem local to the computer system 700 receives the instructions and data on a telephone line and uses an infra-red transmitter to convert the instructions and data to a signal on an infra-red carrier wave serving as the network link 778. An infrared detector serving as communications interface 770 receives the instructions and data carried in the infrared signal and places information representing the instructions and data onto bus 710. Bus 710 carries the information to memory 704 from which processor 702 retrieves and executes the instructions using some of the data sent with the instructions. The instructions and data received in memory 704 may optionally be stored on storage device 708, either before or after execution by the processor 702.

FIG. 8 illustrates a chip set or chip 800 upon which an embodiment of the invention may be implemented. Chip set 800 is programmed to determine the position and/or a travel path of a device as described herein and includes, for instance, the processor and memory components described with respect to FIG. 7 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 800 can be implemented in a single chip. It is further contemplated that in certain embodiments the chip set or chip 800 can be implemented as a single “system on a chip.” It is further contemplated that in certain embodiments a separate ASIC would not be used, for example, and that all relevant functions as disclosed herein would be performed by a processor or processors. Chip set or chip 800, or a portion thereof, constitutes a means for performing one or more steps of determining the position and/or travel path of a device independent of, or in addition to, conventional GPS triangulation.

In one embodiment, the chip set or chip 800 includes a communication mechanism such as a bus 801 for passing information among the components of the chip set 800. A processor 803 has connectivity to the bus 801 to execute instructions and process information stored in, for example, a memory 805. The processor 803 may include one or more processing cores with each core configured to perform independently. A multi-core processor enables multiprocessing within a single physical package. Examples of a multi-core processor include two, four, eight, or greater numbers of processing cores. Alternatively or in addition, the processor 803 may include one or more microprocessors configured in tandem via the bus 801 to enable independent execution of instructions, pipelining, and multithreading. The processor 803 may also be accompanied with one or more specialized components to perform certain processing functions and tasks such as one or more digital signal processors (DSP) 807, or one or more application-specific integrated circuits (ASIC) 809. A DSP 807 typically is configured to process real-world signals (e.g., sound) in real time independently of the processor 803. Similarly, an ASIC 809 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 800 includes merely one or more processors and some software and/or firmware supporting and/or relating to and/or for the one or more processors.

The processor 803 and accompanying components have connectivity to the memory 805 via the bus 801. The memory 805 includes both dynamic memory (e.g., RAM, magnetic disk, writable optical disk, etc.) and static memory (e.g., ROM, CD-ROM, etc.) for storing executable instructions that when executed perform the inventive steps described herein to determine the position and/or a travel path of a device. The memory 805 also stores the data associated with or generated by the execution of the inventive steps.

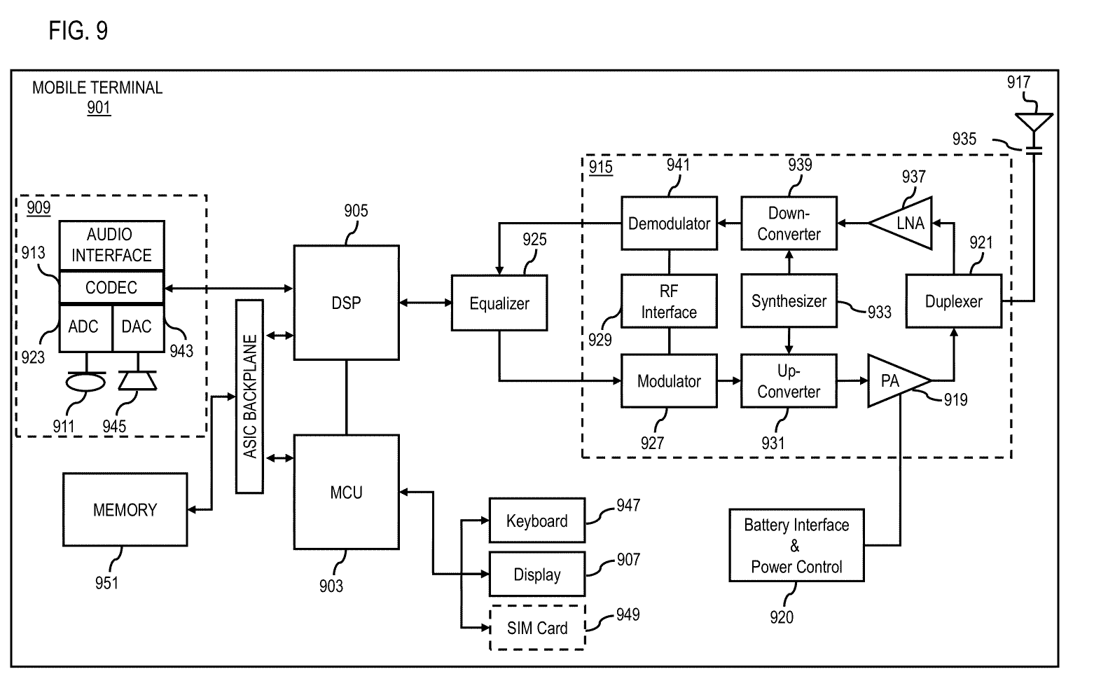

FIG. 9 is a diagram of exemplary components of a mobile terminal (e.g., handset) for communications, which is capable of operating in the system of FIG. 1, according to one embodiment. In some embodiments, mobile terminal 901, or a portion thereof, constitutes a means for performing one or more steps of determining the position and/or travel path of a device independent of, or in addition to, conventional GPS triangulation. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 903, a Digital Signal Processor (DSP) 905, and a receiver/transmitter unit including a microphone gain control unit and a speaker gain control unit. A main display unit 907 provides a display to the user in support of various applications and mobile terminal functions that perform or support the steps of determining the position and/or travel path of a device independent of, or in addition to, conventional GPS triangulation. The display 907 includes display circuitry configured to display at least a portion of a user interface of the mobile terminal (e.g., mobile telephone). Additionally, the display 907 and display circuitry are configured to facilitate user control of at least some functions of the mobile terminal. An audio function circuitry 909 includes a microphone 911 and microphone amplifier that amplifies the speech signal output from the microphone 911. The amplified speech signal output from the microphone 911 is fed to a coder/decoder (CODEC) 913.

A radio section 915 amplifies power and converts frequency in order to communicate with a base station, which is included in a mobile communication system, via antenna 917. The power amplifier (PA) 919 and the transmitter/modulation circuitry are operationally responsive to the MCU 903, with an output from the PA 919 coupled to the duplexer 921 or circulator or antenna switch, as known in the art. The PA 919 also couples to a battery interface and power control unit 920.

In use, a user of mobile terminal 901 speaks into the microphone 911 and his or her voice along with any detected background noise is converted into an analog voltage. The analog voltage is then converted into a digital signal through the Analog to Digital Converter (ADC) 923. The control unit 903 routes the digital signal into the DSP 905 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 925 for compensation of any frequency-dependent impairments that occur during transmission though the air such as phase and amplitude distortion. After equalizing the bit stream, the modulator 927 combines the signal with a RF signal generated in the RF interface 929. The modulator 927 generates a sine wave by way of frequency or phase modulation. In order to prepare the signal for transmission, an up-converter 931 combines the sine wave output from the modulator 927 with another sine wave generated by a synthesizer 933 to achieve the desired frequency of transmission. The signal is then sent through a PA 919 to increase the signal to an appropriate power level. In practical systems, the PA 919 acts as a variable gain amplifier whose gain is controlled by the DSP 905 from information received from a network base station. The signal is then filtered within the duplexer 921 and optionally sent to an antenna coupler 935 to match impedances to provide maximum power transfer. Finally, the signal is transmitted via antenna 917 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 901 are received via antenna 917 and immediately amplified by a low noise amplifier (LNA) 937. A down-converter 939 lowers the carrier frequency while the demodulator 941 strips away the RF leaving only a digital bit stream. The signal then goes through the equalizer 925 and is processed by the DSP 905. A Digital to Analog Converter (DAC) 943 converts the signal and the resulting output is transmitted to the user through the speaker 945, all under control of a Main Control Unit (MCU) 903 which can be implemented as a Central Processing Unit (CPU).

The MCU 903 receives various signals including input signals from the keyboard 947. The keyboard 947 and/or the MCU 903 in combination with other user input components (e.g., the microphone 911) comprise a user interface circuitry for managing user input. The MCU 903 runs a user interface software to facilitate user control of at least some functions of the mobile terminal 901 to determine the position and/or a travel path of a device. The MCU 903 also delivers a display command and a switch command to the display 907 and to the speech output switching controller, respectively. Further, the MCU 903 exchanges information with the DSP 905 and can access an optionally incorporated SIM card 949 and a memory 951. In addition, the MCU 903 executes various control functions required of the terminal. The DSP 905 may, depending upon the implementation, perform any of a variety of conventional digital processing functions on the voice signals. Additionally, DSP 905 determines the background noise level of the local environment from the signals detected by microphone 911 and sets the gain of microphone 911 to a level selected to compensate for the natural tendency of the user of the mobile terminal 901.

The CODEC 913 includes the ADC 923 and DAC 943. The memory 951 stores various data including call incoming tone data and is capable of storing other data including music data received via, e.g., the global Internet. The software module could reside in RAM memory, flash memory, registers, or any other form of writable storage medium known in the art. The memory device 951 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 949 carries, for instance, important information, such as the cellular phone number, the carrier supplying service, subscription details, and security information. The SIM card 949 serves primarily to identify the mobile terminal 901 on a radio network. The card 949 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
causing, at least in part, a position of a device to be defined as a first position;
determining accelerometer data associated with the device during a movement of the device from the first position to a second position;
processing the accelerometer data to determine a step rate of a user of the device during the movement of the device from the first position to the second position;
determining a step length of the user based, at least in part, on a user profile associated with the user;
determining a direction of movement of the device during the movement from the first position to the second position; and
processing the step rate, the step length, and the direction of movement of the device to determine a location of the second position with respect to the first position.

2. A method of claim 1, wherein the accelerometer data indicates a rhythm with which the device accelerates during the movement of the device from the first position to the second position.

3. A method of claim 1, wherein the accelerometer data is processed using a Fast Fourier Transform to determine the step rate.

4. A method of claim 1, further comprising:
causing, at least in part, the user profile to be generated based, at least in part, on collected accelerometer data during a training period.

5. A method of claim 1, wherein the user profile is stored and accessible by one or more devices.

6. A method of claim 1, further comprising:
determining sensor data including an angular velocity of the device; and
causing, at least in part, the angular velocity of the device to be integrated with respect to time to determine the direction of movement of the device.

7. A method of claim 1, wherein the direction is determined by way of a compass associated with the device.

8. A method of claim 1, further comprising:
determining a change in the direction of movement of the device from the direction of movement of the device from the first position to the second position to another direction of movement of the device;
causing, at least in part, the second position to be defined as another first position based, at least in part, on the determination of the change in direction of movement of the device;
determining additional accelerometer data associated with the device during a movement of the device from the another first position to another second position;
processing the additional accelerometer data to determine another step rate of the user of the device during the movement of the device from the another first position to the another second position;
determining the another direction of movement of the device during the movement of the device from the another first position to the another second position; and
processing the another step rate, the step length, and the another direction of movement of the device from the another first position to the another second position to determine a location of the another second position with respect to the another first position.

9. A method of claim 8, further comprising:
determining an overall travel path based, at least in part, on a compilation of one or more individual travel paths generated based on the movement from the first position to the second position, the movement from the another first position to the another second position, one or more other movements from one or more other first positions to one or more respective other second positions, or any combination thereof.

10. A method of claim 1, further comprising:
causing, at least in part, one or more of the first position, the second position, the another first position, the another second position, the one or more other first positions, the one or more respective other second positions, individual travel paths, the overall travel path, or any combination thereof to be displayed.

11. An apparatus comprising:
at least one processor; and
at least one memory including computer program code for one or more programs,
the at least one memory and the computer program code configured to, with the at least one processor, cause the apparatus to perform at least the following,
cause, at least in part, a position of a device to be defined as a first position;
determine accelerometer data associated with the device during a movement of the device from the first position to a second position;
process the accelerometer data to determine a step rate of a user of the device during the movement of the device from the first position to the second position;
determine a step length of the user based, at least in part, on a user profile associated with the user;
determine a direction of movement of the device during the movement from the first position to the second position; and
process the step rate, the step length, and the direction of movement of the device to determine a location of the second position with respect to the first position.

12. An apparatus of claim 11, wherein the accelerometer data indicates a rhythm with which the device accelerates during the movement of the device from the first position to the second position.

13. An apparatus of claim 11, wherein the accelerometer data is processed using a Fast Fourier Transform to determine the step rate.

14. An apparatus of claim 11, wherein the apparatus is further caused to:
cause, at least in part, the user profile to be generated based, at least in part, on collected accelerometer data during a training period.

15. An apparatus of claim 11, wherein the user profile is stored and accessible by one or more devices.

16. An apparatus of claim 11, wherein the apparatus is further caused to:
determine sensor data including an angular velocity of the device; and
cause, at least in part, the angular velocity of the device to be integrated with respect to time to determine the direction of movement of the device.

17. An apparatus of claim 11, wherein the direction is determined by way of a compass associated with the device.

18. An apparatus of claim 11, wherein the apparatus is further caused to:
determine a change in the direction of movement of the device from the direction of movement of the device from the first position to the second position to another direction of movement of the device;
cause, at least in part, the second position to be defined as another first position based, at least in part, on the determination of the change in direction of movement of the device;
determine additional accelerometer data associated with the device during a movement of the device from the another first position to another second position;
process the additional accelerometer data to determine another step rate of the user of the device during the movement of the device from the another first position to the another second position;
determine the another direction of movement of the device during the movement of the device from the another first position to the another second position; and
process the another step rate, the step length, and the another direction of movement of the device from the another first position to the another second position to determine a location of the another second position with respect to the another first position.

19. An apparatus of claim 18, wherein the apparatus is further caused to:
determine an overall travel path based, at least in part, on a compilation of one or more individual travel paths generated based on the movement from the first position to the second position, the movement from the another first position to the another second position, one or more other movements from one or more other first positions to one or more respective other second positions, or any combination thereof.

20. An apparatus of claim 11, wherein the apparatus is further caused to:
cause, at least in part, one or more of the first position, the second position, the another first position, the another second position, the one or more other first positions, the one or more respective other second positions, individual travel paths, the overall travel path, or any combination thereof to be displayed.

21. A computer-readable storage medium carrying one or more sequences of one or more instructions which, when executed by one or more processors, cause an apparatus to perform at least the following,
cause, at least in part, a position of a device to be defined as a first position;
determine accelerometer data associated with the device during a movement of the device from the first position to a second position;
process the accelerometer data to determine a step rate of a user of the device during the movement of the device from the first position to the second position;
determine a step length of the user based, at least in part, on a user profile associated with the user;
determine a direction of movement of the device during the movement from the first position to the second position; and
process the step rate, the step length, and the direction of movement of the device to determine a location of the second position with respect to the first position.

22. A computer-readable storage medium of claim 21, wherein the accelerometer data indicates a rhythm with which the device accelerates during the movement of the device from the first position to the second position.

23. A computer-readable storage medium of claim 21, wherein the accelerometer data is processed using a Fast Fourier Transform to determine the step rate.

24. A computer-readable storage medium of claim 21, wherein the apparatus is further caused to:
cause, at least in part, the user profile to be generated based, at least in part, on collected accelerometer data during a training period.

25. A computer-readable storage medium of claim 21, wherein the user profile is stored and accessible by one or more devices.

26. A computer-readable storage medium of claim 21, wherein the apparatus is further caused to:
determine sensor data including an angular velocity of the device; and
cause, at least in part, the angular velocity of the device to be integrated with respect to time to determine the direction of movement of the device.

27. A computer-readable storage medium of claim 21, wherein the direction is determined by way of a compass associated with the device.

28. A computer-readable storage medium of claim 21, wherein the apparatus is further caused to:
determine a change in the direction of movement of the device from the direction of movement of the device from the first position to the second position to another direction of movement of the device;
cause, at least in part, the second position to be defined as another first position based, at least in part, on the determination of the change in direction of movement of the device;
determine additional accelerometer data associated with the device during a movement of the device from the another first position to another second position;
process the additional accelerometer data to determine another step rate of the user of the device during the movement of the device from the another first position to the another second position;
determine the another direction of movement of the device during the movement of the device from the another first position to the another second position; and
process the another step rate, the step length, and the another direction of movement of the device from the another first position to the another second position to determine a location of the another second position with respect to the another first position.

29. A computer-readable storage medium of claim 28, wherein the apparatus is further caused to:
determine an overall travel path based, at least in part, on a compilation of one or more individual travel paths generated based on the movement from the first position to the second position, the movement from the another first position to the another second position, one or more other movements from one or more other first positions to one or more respective other second positions, or any combination thereof.

30. A computer-readable storage medium of claim 21, wherein the apparatus is further caused to:
cause, at least in part, one or more of the first position, the second position, the another first position, the another second position, the one or more other first positions, the one or more respective other second positions, individual travel paths, the overall travel path, or any combination thereof to be displayed.
